(19) United States
(12) Patent Application Publication
(10) Pub. No.: US 2003/0057668 A1
(43) Pub. Date: Mar. 27, 2003

(54) Hand truck attachment

(76) Inventor: Frank Peters, Shafter, CA (US)

Correspondence Address: James M. Duncan, Klein, DeNatale, Goldner, etc, P.O. Box 11172, Bakersfield, CA, 93389-1172, US

(21) Appl. No.: 10/282,860

(22) Filed: Oct. 28, 2002

Related U.S. Application Data
(63) Continuation-in-part of application No. 09/735,881, filed on Dec. 12, 2000.

(51) Int. Cl. B62B 1/00; B62B 7/02

(52) U.S. Cl. 280/47.24

(57) ABSTRACT

An attachment which is readily installed on a conventional hand truck, providing additional load bearing area and restraining points, thereby increasing the utility of the hand truck, and making the hand truck safer to operate. The attachment may be manually removed from the hand truck, not requiring the use of any tools. The attachment may also function as a storage rack, even when removed from the hand truck.

### CROSS-REFERENCE TO RELATED APPLICATION

This is a continuation-in-part of U.S. application Ser. No. 09/735,881, filed on Dec. 12, 2000, to which the inventor claims domestic priority, and which is incorporated by reference herein.

### BACKGROUND OF THE INVENTION

The present invention is directed to hand trucks and particularly to a hand truck attachment which readily attaches to a hand truck thereby allowing different types, shapes and sizes of items to be transported by the hand truck.

Conventional hand trucks are manually propelled and generally comprise a frame with a handle on the upper end of the frame, wheels at the lower end of the frame, and a toe plate attached at the lower end of the frame, where the toe plate is generally perpendicular to the frame. Items carried on the hand truck are stacked on the toe plate, and the frame is rocked backwards, tilting on the wheels so that the items rest against the frame as the hand truck is wheeled to the desired location. However, the types, shapes and sizes of items which may be transported on a conventional hand truck are limited. Typically, a conventional hand truck works best for moving boxes, bags, and barrels. Items which are not placed directly on the toe plate may not be stable during transporting the hand truck, and those items may fall off through the frame members, to the side, or the front of the hand truck because the only points of support provided by a conventional hand truck are at the toe plate and at the frame supports. Small items and items which are not readily stackable are even more difficult to transport by a conventional hand truck, because of the lack of support points.

Various ideas have been proposed for modifying a conventional hand truck to provide greater utility in transporting different items. For example, U.S. Pat. No. 4,726,602 (Sanders) discloses a hand truck for handling bulky freight. This hand truck has a large cage or freight supporting surface with three walls, which may be used to support and carry bulky freight such as loaf bread, plastic foam objects and the like. However, the front of this hand truck is open. When this hand truck is not being used, the side members and the toe plate extension can be folded to permit the hand truck to be carried by a supply truck or stored without occupying an undue amount of space. The side members and toe plate extension are not readily detachable from the hand truck.

U.S. Pat. No. 5,465,987 discloses an attachment to a conventional hand truck which readily attaches to increase the ease of carrying small articles. This attachment comprises a foldable panel system which provides lateral support for articles loaded on the band truck. The three panels include a back plate and two side plates. However the only support provided at the front of the hand truck are straps which extend across the two side plates. The attachment provides no additional load-bearing area to the toe plate.

### SUMMARY OF THE INVENTION

One embodiment of the disclosed invention is directed to an apparatus which readily attaches to a conventional hand truck, and may be manually removed, i.e., without tools, once use of the hand truck has been completed. As a further advantage the present invention provides additional load-bearing area to the toe plate thereby increasing the capacity of a conventional hand truck. When removed, the disclosed apparatus may also function as a storage rack.

The conventional hand truck is comprised of a vertical ladder-back frame which includes a plurality of horizontal cross-braces extending between vertical side rails from an upper end of the frame to a lower end of the frame. The frame typically has a handle at the top and a pair of axle-mounted wheels at a bottom. The frame has a toe plate affixed to the bottom, which extends substantially horizontally from the front of the frame. One embodiment of the present invention comprises a plurality of cage members, each cage member comprising a lower cargo bearing section, a front restraining section and an upper enclosing section. The lower cargo bearing section is supported by the toe plate and extends forward. The front restraining section comprises the vertical portion of the cage member, and the upper enclosing section comprises the portion of the cage member continuing backwardly to the upper end of the frame. A first connecting means connects the lower cargo bearing section of each cage member to a horizontal cross-brace at the lower end of the frame and a second connecting means connects the upper enclosing section of each cage member to a horizontal cross-brace at the upper end of the frame. A plurality of cross-supports connecting adjacent cage members.

### BRIEF DESCRIPTION OF THE DRAWINGS

FIG. 1 is a perspective view of one embodiment of the disclosed invention attached to a conventional hand truck.

FIG. 2 is a perspective view of one embodiment of the disclosed invention, detached from a hand truck.

FIG. 3 shows a top view of an alternative means of attaching the upper end of one embodiment to a conventional hand truck.

FIG. 4 shows a side view of an alternative means of attaching the lower end of one embodiment to a conventional hand truck.

FIG. 5 shows an isometric view of an alternative embodiment of the disclosed invention attached to a conventional hand truck.

FIG. 6 shows how one embodiment of the disclosed invention may be used as a storage rack.

FIG. 7 shows how an alternative embodiment of the disclosed invention may be used as a storage rack.

### DETAILED DESCRIPTION OF THE EMBODIMENTS

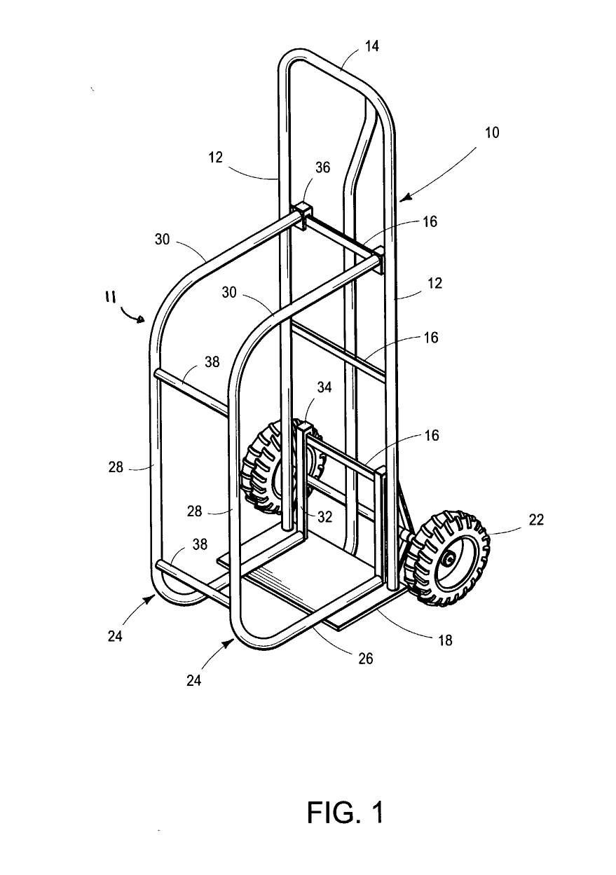

As shown in FIG. 1, a conventional hand truck comprises a ladder-back frame 10, two vertical side rails, 12, a handle 14, horizontal cross-braces 16, a toe plate 18, and wheels 22. One disclosed embodiment of the invention comprises attachment 11, the attachment comprising a plurality of cage members 24, each cage member comprising a lower cargo bearing section 26, a front restraining section 28, and an upper enclosing section 30. The cage members 24 may be constructed of a malleable, moldable or weldable material, such as thin wall mild steel tubing. If smaller items are to be carried on the hand truck, it may be desirable to have more than two cage members 24 so that there will be less space between the cage members. The embodiment shown in FIG. 1 has two cage members 24, which reduces the cost and weight of the invention.

Each cage member 24 of attachment 11 may comprise three different sections, the lower cargo bearing section 26, the front restraining section 28 and the upper enclosing section 30. The lower cargo bearing section 26 is generally horizontal, supported by the toe plate 18 and extending from the front edge of the toe plate. The front restraining section 28 is the generally vertical section of each cage member which restrains cargo loaded on the hand truck from sliding forward. From the generally vertical front restraining section 28, each cage member 24 curves back at the top to connect the cage member to the ladder back frame 10, the horizontal portion of the cage member 28 forming the upper enclosing section 30.

The lower cargo bearing section 26 of each cage member 24 is supported by toe plate 18. The lower cargo bearing section 26 extends out beyond the front edge of the toe plate 18, following a plane parallel to the plane of the toe plate, thus providing a load bearing area which extends beyond the edge of the toe plate. Connecting means, such as a lower hanger assembly 32, terminating in a hanger 34, may connect each cage member 24 to a horizontal cross-brace 16 of the hand cart. As shown in FIGS. 1 and 4, the lower hanger assembly 32 and hanger 34 may be constructed of flat metal stock or of flattened tubing. The hanger 34 may be formed at the upper end of the hanger assembly into a U-shaped configuration, as shown in FIG. 1. Alternatively, the hanger 34′ may be formed in a V-shaped configuration as shown in FIG. 4. For either configuration, the lower hanger assembly 34 or 34′ is hung on the horizontal cross-brace 16.

The front restraining section 28 of each cage member 24 is substantially vertical, extending from the end of the lower cargo bearing section 26 at the lower end of the hand truck to the end of the upper enclosing section 30 of the cage member. As shown in FIG. 1, the front restraining sections 28 of each cage member 24 define a plane generally parallel to the plane formed by the ladder-back frame 10 of the hand truck. The front restraining sections 28 provide rigid support points for cargo transported by the hand truck. For example, when transporting items such as cinder blocks, the front restraining sections 28 provide front support to prevent the blocks from tumbling from the front of the hand truck. The front restraining sections 28 further provide support to items which do not readily stack. For example, firewood is not easily transported by a conventional hand truck because the rounded pieces tend to roll. However, the present invention provides additional support points to firewood so that it may be stacked and easily transported with the hand truck.

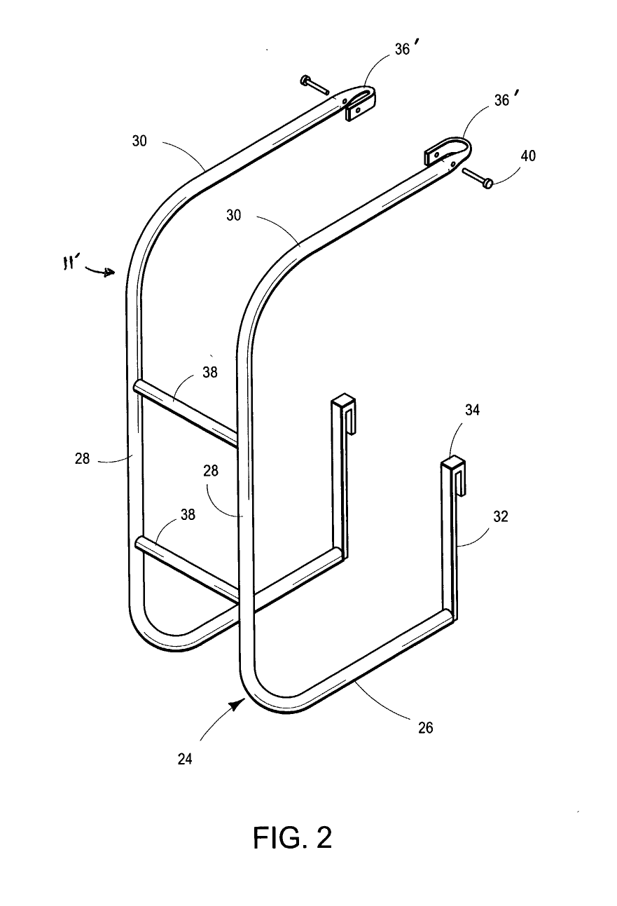

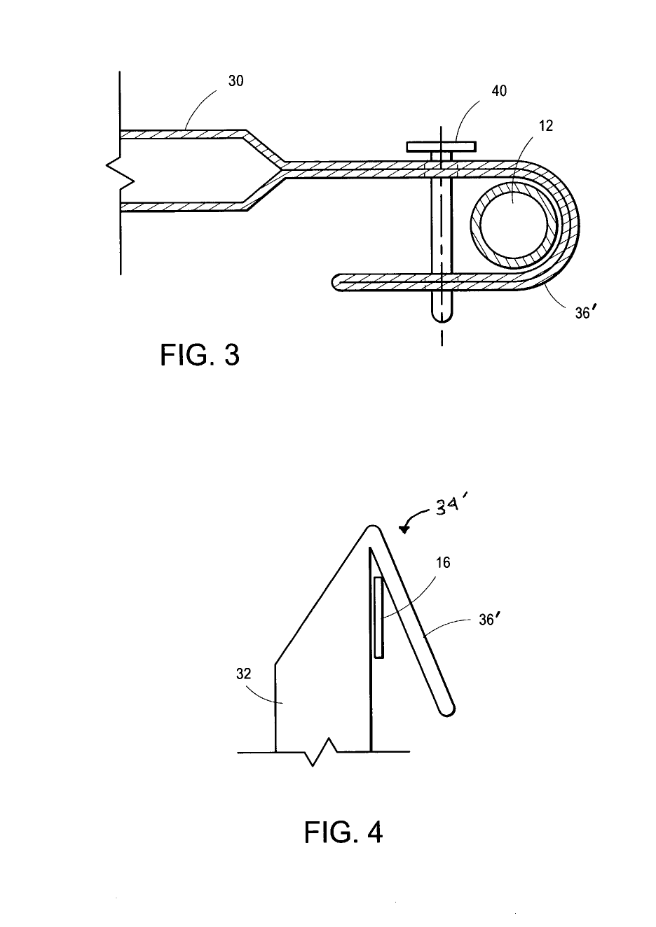

The upper enclosing section 30 provides horizontal containment and support for cargo transported by the hand truck. The upper enclosing section 30 extends from the top of the front restraining section 28 backward to the ladder-back frame 10 of the hand truck. As shown in FIG. 1, the upper enclosing section 30 may be attached to a horizontal cross-brace 16 of the ladder-back frame 10 by means of an attachment bracket 36, where the attachment bracket is generally U-shaped as depicted in FIG. 1. Alternatively, the attachment bracket 36 may be generally V-Shaped and formed by connecting two plates together at the top. As depicted in FIG. 2 and FIG. 3, the upper enclosing section 30 may also be attached to a vertical side rail 12 using a universal mount 36′. The universal mount is formed by terminating the upper enclosing section 30 in the shape of a “U,” configured to fit around each vertical side rail 12. The universal mount 36′ is further secured by a retaining pin 40, which may be removed by hand.

Adjacent cage members 24 are attached to one another with horizontal cross-supports 38. The cross-supports provide further contact points for cargo carried on the hand truck. Side panels constructed of metal screening, plastic, or other light weight materials may be attached to the front or sides of the cage members 24 to provide additional support or to enable transporting smaller items with the hand truck without the items falling through the space between the cage members.

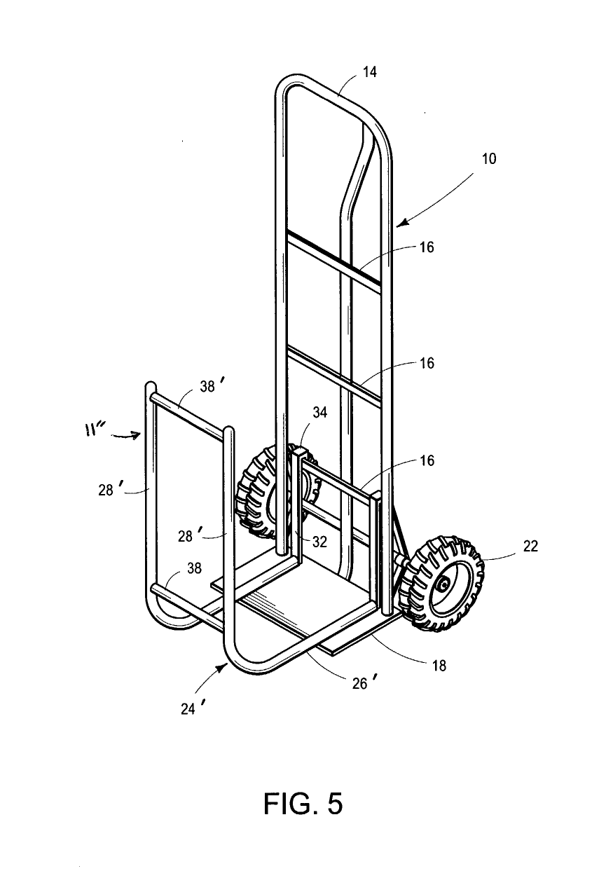

An alternative embodiment 11′ of the invention is disclosed in FIG. 5. In this embodiment, each cage member 24′ is comprised of two different sections, the lower cargo bearing section 26′ and the front restraining section 28′. The lower cargo bearing section 26′ is generally horizontal, and supported by the toe plate 18 and extending from the front edge of the toe plate 18. The front restraining section 28′ is the generally vertical section of each cage member which restrains cargo loaded on the hand truck from sliding forward. Adjacent cage members 24′ are attached to one another with horizontal cross-supports 38′. In this embodiment 11′, because there is only one connection of each cage member 24′ to the ladder-back frame 10 of the hand truck, the cage members may be constructed of a more rigid material than the embodiment disclosed in FIG. 1.

In addition to use of the disclosed invention for transporting various items, such as cinder blocks, fire wood, and boxes, the disclosed invention, when attached to a hand truck, provides a portable storage rack for these items. This use may be accomplished by removing simply lowering the handle 14 of the hand truck to the ground, so that the ladder back frame 10 is parallel to the ground and resting on the ground. Items may then be stored within the cage members 24.

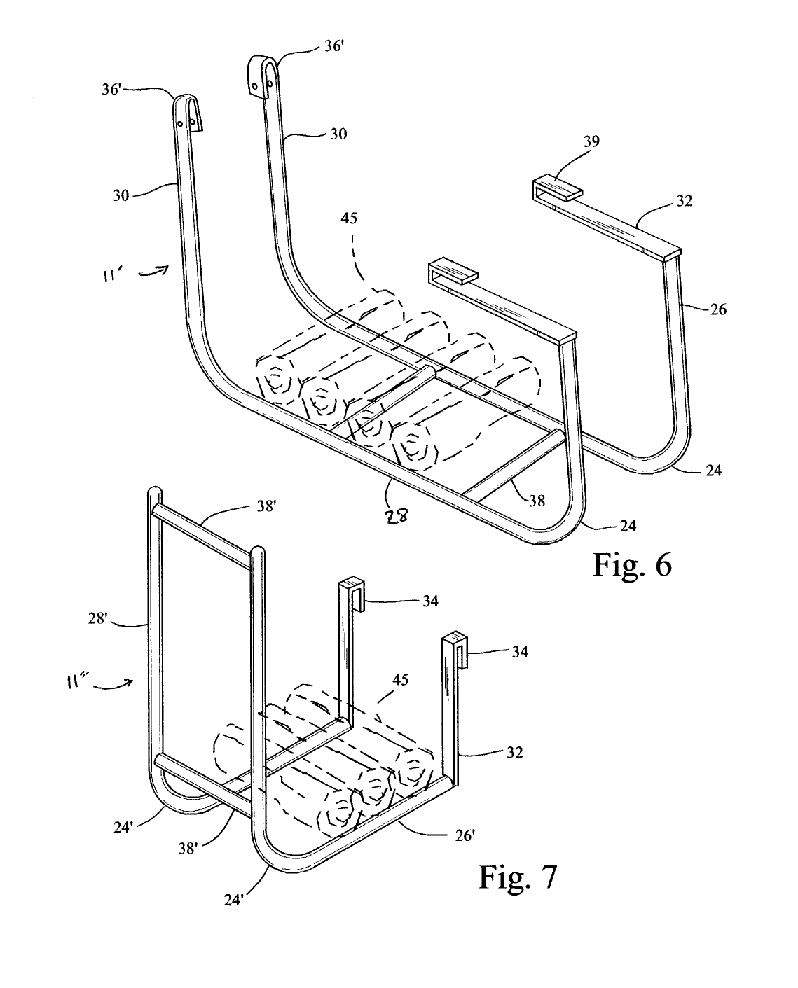

However, attachment 11, as depicted in FIG. 1, is easily removed from the hand truck by simply lifting attachment 11 upwards. It is to be appreciated that no tools are required to remove attachment 11 from the hand truck, such that the attachment 11 is manually-removeable from the hand truck. Another embodiment 11′, shown is FIG. 2, is removed from the band truck by simply removing retaining pin 40 and disengaging universal mount 36′ from vertical side rail 12. As with the embodiment 11 depicted in FIG. 1, the embodiment 11′ shown in FIG. 2 requires no tools to remove from the hand truck and is manually-removeable. Attachment 11 or Attachment 11′ may be used, without the hand truck, as a storage rack. For example, FIG. 6 shows attachment 11′ removed from the hand truck and placed on the ground or floor surface such that the attachment is resting on front engagement members 28. Items may then be stored on attachment 11′, such as firewood 45 or other items or materials, which might otherwise roll or shift unless contained. This feature of the device allows it to be multi-functional, such that it not only increases the carrying capacity of a hand truck, but also provides a convenient storage rack standing alone.

A third embodiment, attachment 11″, is manually removeable from the hand truck by simply lifting upwards, This embodiment may also be used as a storage rack as shown in FIG. 7, with lower cargo bearing sections 26′ resting on the ground or floor surface.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A manually-removeable attachment used in combination with a hand truck, the hand truck comprising a vertical ladder-back frame including a plurality of horizontal cross-braces extending between vertical side rails from an upper end of the frame to a lower end of the frame, said frame having a handle at the top and axle-mounted wheels at a bottom and a toe plate affixed to the bottom of said frame and extending substantially horizontally from the front of the frame, the attachment comprising:
(a) a plurality of cage members, each cage member comprising a lower cargo bearing section, a front cargo restraining section and an upper cargo enclosing section, the lower cargo bearing section supported by the toe plate and extending forward, the front cargo restraining section comprising the vertical portion of the cage member, and the upper cargo enclosing section comprising the portion of the cage member extending from the front cargo restraining section to the upper end of the frame;
(b) a first attachment means connecting the lower cargo bearing section of each cage member to a horizontal cross-brace at the lower end of the frame;
(c) a second attachment means connecting the upper cargo enclosing section of each cage member to a horizontal cross-brace at the upper end of the frame; and
(d.) a plurality of cross-supports connecting the cage members.

2. The attachment of claim 1 wherein the first connecting means comprises a hanger assembly, said hanger assembly having a bottom end attached to the lower cargo bearing section and an upper end configured into a hanger to fit over the horizontal cross-brace at the lower end of the frame.

3. The attachment of claim 1 wherein the second connecting means comprises a bracket connected to the upper cargo enclosing section, said bracket adapted to fit over the horizontal cross-brace at the upper end of the frame.

4. The attachment of claim 3 wherein the bracket is configured in a “U” shape.

5. The attachment of claim 3 wherein the bracket is configured in a “V” shape.

6. The attachment of claim 1 wherein the cage members are configured in a “U” shape.

7. A manually-removeable attachment used in combination with a hand truck, the hand truck comprising a vertical ladder-back frame including a plurality of horizontal cross-braces extending between vertical side rails from an upper end of the frame to a lower end of the frame, said frame having a handle at the top and axle-mounted wheels at a bottom and a toe plate affixed to the bottom of said frame and extending substantially horizontally from the front of the frame, the attachment comprising:
(a) two cage members, each cage member comprising a lower cargo bearing section, a front cargo restraining section and an upper cargo enclosing section, the lower cargo bearing section supported by the toe plate and extending forward, the front cargo restraining section comprising the vertical portion of the cage member, and the upper cargo enclosing section comprising the portion of the cage member extending from the front cargo restraining section to the upper end of the frame;
(b) a first attachment means connecting the lower cargo bearing section of each cage member to a horizontal cross-brace at the lower end of the frame;
(c) a second attachment means connecting the upper cargo enclosing section of each cage member to a horizontal cross-brace at the upper end of the frame; and
(d.) a plurality of cross-supports connecting the cage members.

8. The attachment of claim 7 wherein the first connecting means comprises a hanger assembly, said hanger assembly having a bottom end attached to the lower cargo bearing section and an upper end configured into a hanger to fit over the horizontal cross-brace at the lower end of the frame.

9. The attachment of claim 7 wherein the second connecting means comprises a bracket connected to the upper cargo enclosing section, said bracket adapted to fit over the horizontal cross-brace at the upper end of the frame.

10. The attachment of claim 9 wherein the bracket is configured in a “U” shape.

11. The attachment of claim 9 wherein the bracket is configured in a “V” shape.

12. The attachment of claim 7 wherein the cage members are configured in a “U” shape.

13. A manually-removeable attachment used in combination with a hand truck, the hand truck comprising a vertical ladder-back frame including a plurality of horizontal cross-braces extending between vertical side rails from an upper end of the frame to a lower end of the frame, said frame having a handle at the top and axle-mounted wheels at a bottom and a toe plate affixed to the bottom of said frame and extending substantially horizontally from the front of the frame, the attachment comprising:
(a) two cage members, each cage member comprising a lower cargo bearing section, a front cargo restraining section and an upper cargo enclosing section, the lower cargo bearing section supported by the toe plate and extending forward, the front cargo restraining section comprising the vertical portion of the cage member, and the upper cargo enclosing section comprising the portion of the cage member extending from the front cargo restraining section to the upper end of the frame;
(b) a first connecting means connecting the lower cargo bearing section of each cage member to a horizontal cross-brace at the lower end of the frame;
(c) a second connecting means connecting the upper cargo enclosing section of each cage member to a vertical side rail at the upper end of the frame; and
(d) a plurality of cross-supports connecting the cage members.

14. The attachment of claim 13 wherein the first connecting means comprises a hanger assembly, said hanger assembly having a lower end attached to the lower cargo bearing section and an upper end configured into a hanger to fit over the horizontal cross-brace at the lower end of the frame.

15. The attachment of claim 13 wherein the second connecting means comprises a universal mount connected to the vertical side rail.

16. A manually-removeable attachment used in combination with a hand truck, the hand truck comprising a vertical ladder-back frame including a plurality of horizontal cross-braces extending between vertical side rails from an upper end of the frame to a lower end of the frame, said frame having a handle at the top and axle-mounted wheels at a bottom and a toe plate affixed to the bottom of said frame and extending substantially horizontally from the front of the frame, the attachment comprising:
(a) two cage members, each cage member comprising a lower cargo bearing section and a front cargo restraining section, the lower cargo bearing section supported by the toe plate and extending forward, and the front cargo restraining section comprising the vertical portion of the cage member;
(b) a first connecting means connecting the lower cargo bearing section of each cage member to a horizontal cross-brace at the lower end of the frame; and
(c) a plurality of cross-supports connecting the cage members.

17. The attachment of claim 16 wherein the first connecting means comprises a hanger assembly, said hanger assembly having a bottom end supported by the lower cargo bearing section and an upper end configured into a hanger to fit over the horizontal cross-brace at the lower end of the frame.

18. A manually-removeable hand truck attachment which functions as a storage rack when removed from the hand truck, the hand truck comprising a vertical ladder-back frame including a plurality of horizontal cross-braces extending between vertical side rails from an upper end of the frame to a lower end of the frame, said frame having a handle at the top and axle-mounted wheels at a bottom and a toe plate affixed to the bottom of said frame and extending substantially horizontally from the front of the frame, the attachment comprising:
(a) two cage members, each cage member comprising a lower cargo bearing section, a front cargo restraining section and an upper cargo enclosing section, the lower cargo bearing section supported by the toe plate and extending forward, the front cargo restraining section comprising the vertical portion of the cage member, and the upper cargo enclosing section comprising the portion of the cage member extending from the front cargo restraining section to the upper end of the frame;
(b) a first attachment means connecting the lower cargo bearing section of each cage member to a horizontal cross-brace at the lower end of the frame;
(c) a second attachment means connecting the upper cargo enclosing section of each cage member to a horizontal cross-brace at the upper end of the frame; and
(d.) a plurality of cross-supports connecting the cage members.

19. A manually-removeable hand truck attachment which functions as a storage rack when removed from the hand truck, the hand truck comprising a vertical ladder-back frame including a plurality of horizontal cross-braces extending between vertical side rails from an upper end of the frame to a lower end of the frame, said frame having a handle at the top and axle-mounted wheels at a bottom and a toe plate affixed to the bottom of said frame and extending substantially horizontally from the front of the frame, the attachment comprising:
(a) two cage members, each cage member comprising a lower cargo bearing section and a front cargo restraining section, the lower cargo bearing section supported by the toe plate and extending forward, and the front cargo restraining section comprising the vertical portion of the cage member;
(b) a first connecting means connecting the lower cargo bearing section of each cage member to a horizontal cross-brace at the lower end of the frame; and
(c) a plurality of cross-supports connecting the cage members.
